(19) United States
(12) Patent Application Publication
(10) Pub. No.: US 2017/0240983 A1
(43) Pub. Date: Aug. 24, 2017

(54) ACCESS PORT ARRANGEMENT AND METHOD OF FORMING THEREOF

(71) Applicant: Swansea University, Swansea (GB)

(72) Inventors: Szymon Kubal, Swansea (GB); Albert Wraith, Exeter Devon (GB); Cameron George Pleydell-Pearce, Vale Of Glamorgan (GB)

(21) Appl. No.: 15/512,953

(22) PCT Filed: Sep. 23, 2015
(86) PCT No.: PCT/GB2015/052757

§ 371 Date: Mar. 21, 2017

(30) Foreign Application Priority Data
Sep. 23, 2014 (GB) 1416805.8

(51) Int. Cl. C21C 5/48; F27D 3/16

(52) U.S. Cl. CPC C21C 5/48; F27D 3/16; F27D 2003/161

(57) ABSTRACT

The present invention relates to an access port arrangement and in particular an access port arrangement capable of enabling stirring of a molten metal in a vessel. Such arrangements are often called tuyeres. The access port arrangement comprises an inner part forming a core with an outer periphery and an outer part comprising a bore therethrough having an inner periphery positioned around the outer periphery of the inner part with the path way defined by a gap between the outer periphery of the inner part and the inner periphery on the outer part. The arrangement further comprises one or more bridges that span the gap between the outer periphery of the inner part and the inner periphery of the outer part. The inner and outer part are formed of a refractory material.

### FIELD OF THE INVENTION

The present invention relates to an access port arrangement and in particular but not exclusively to an access port arrangement capable of enabling stirring of a molten metal in a vessel. Furthermore, the invention relates to a method of forming such an access port arrangement.

### BACKGROUND OF THE INVENTION

Referring to FIG. 1, in the production of steel for example, the BOS (Basic Oxygen Steelmaking) process is utilised. In such a process, batches of hot metal 2 from the blast furnace are converted into steel in a vessel 4 called a converter or BOF (Basic Oxygen Furnace). Oxygen is blown through a multiple-port lance 6 from above with a purpose of removal of impurities like carbon, silicon and phosphorus that have been introduced in the hot metal and in scrap steel added to the vessel in the processing. As the oxygen is introduced, this burns the carbon present reducing the carbon content of the mixture from around 4.5% down to between 0.04 and 0.06% and raises the vessel temperature. Through the introduction of oxygen and the burning of carbon to form carbon monoxide and carbon dioxide, the mixture in the vessel is stirred. However, as the carbon content of the mixture decreases, the amount of carbon monoxide and carbon dioxide decreases, thus reducing the mixing effect. For this reason, it is known to employ access port assemblies in the form of tuyeres 8 to inject a typically inert gas into the molten metal for the purpose of stirring the molten metal. This maintains the mixing effect. Usually, the tuyeres extend through a refractory lining 10 of a BOF, ladle, degasser or tundish. Further tuyeres are used in order to ensure the proper amount of gas injection into the molten metal to carry out the desired process of decarburization, dephosphorisation, homogeneity of the mixture and uniformity of temperature of the mixture.

Typically tuyeres are formed of stainless steel having a nozzle passing through the tuyere through which gas can be injected into a molten metal. The gas passes out through the nozzle and passes into a metal bath and the gas typically forms a linear path rather than at an angular or circulatory path.

Different forms of tuyeres or gas injection devices have been devised to inject gas into a molten material. U.S. Pat. No. 3,645,520 describes a spiral type lance with is introduced under the surface of a bath of molten steel used primarily for the decarburization of molten metal. Gas is blown under the surface of the molten metal in the bath rather than through the refractory sidewalls of a vessel.

A further known access port arrangement is a tuyere where a plurality of holes are drilled through the refractory material to form bores and stainless steel inserts are inserted into the formed bores. The number of conduits are variable, and can typically be between 24 and 100, each having a stainless steel tube inserted therein.

Another access port arrangement currently used is shown in FIG. 2. In this Figure there is a cut away section showing a stainless steel sleeve 10 inserted through a bore in a refractory brick 12. A core 14 is inserted into this sleeve 10 having a plurality of semi-circular channels 14 formed on the outer peripheral surface having peaks and troughs, where once the core is inserted into the sleeve 10 the peaks abut the inner surface of the sleeve 10 thereby forming a plurality of discrete channels 14 for injection of gas into the vessel. The core 14 itself may have a different core material radially inwardly of the stainless steel.

There are significant problems associated with known access port assemblies such as tuyeres with the insertion of known stainless steel inserts. A first phenomenon is the effect of back attack as a result of molten metal circulation as gas is injected through the channels 14. Gas bubbles form at the distal end of the channel 14 which then break away once an equilibrium is reached. As they do so, molten metal and a small additional partial sphere of gas that is left behind are forced back into contact with the area of the refractory brick surrounding the distal end of the channel 14. The frequency this happens may be around 7 Hz (7 bubbles formed per second). The molten metal impacts the stainless steel inserts and may enter the insert opening and be forced into the interface between the insert and the surrounding refractory, causing damage to both. The gas which is forced back may have a temperature around 400° C. and the molten metal may be at 1400-1700° C., therefore the temperature keeps changing at the area of the brick surrounding the distal end of the channel 14. This, and the metal impact cause wear on the refractory brick material. Increasing the flow rate of the gas injected reduces the frequency but at the same time each impact is greater meaning the detrimental effect remains high.

A further problem results from the cooling effect of the injected gas. The injected gas causes continuous cooling of the area surrounding the gas bubble which can cause solidification of molten metal in the vessel around this area. This solidified metal attaches to the stainless steel inserts. It may be porous or may be solid and its effect is to divert or reduce the flow rate of the gas stream.

When the solidified attachment melts or breaks away during the vessel cycle, massive wear may occur around the distal end of the channel 14, adding to the wear caused by repeated cooling and heating as each bubble forms, thereby increasing the rate of wear.

These effects are difficult to control. Their extent and severity depend upon the characteristics of the refractory materials at the distal end of the assembly and on the presence of stainless steel inserts. Thermal cycling of refractory materials in the distal region of the tuyere due to bubble formation and the vessel process cycle cause thermo-mechanical damage.

A further problem with stainless steel acting as a sacrificial material in a known tuyere is that chromium from the stainless steel is introduced into the molten metal in the vessel affecting the purity of the steel produced.

Wear of a tuyere in a BOF can be as much as 0.3-1 mm per cycle of batch processing and its associated temperature rise.

In order to overcome these deficiencies, after a predetermined number of cycles a tuyere is capped and another bore drilled through the vessel wall for insertion of another stainless steel sleeve. This is time consuming, dangerous, and also it is difficult to ensure that the bore is drilled straight through a single brick without crossing between bricks. Such crossing introduces inherent weakness and potential points of increased wear as the stainless steel wears.

Current tuyeres have extremely short service life due to the significant detrimental effects described above, meaning that typically the tuyere could have eroded to a non-useable state after 800 cycles of heating and cooling of the vessel. The present invention improves this cycle.

The present invention seeks to overcome the problems of the prior art by providing an access port arrangement that is capable of introducing gas into a molten bath so that there is a good dispersion of materials in the bath. Furthermore, the form of the access port arrangement avoids build-up of material or erosion of the distal end of the access port arrangement in communication with molten metal in a vessel in order to improve service life.

### SUMMARY OF THE INVENTION

According to a first aspect of the invention there is provided an access port arrangement for the introduction of gas into a molten metal to cause stirring of the molten metal, said access port arrangement having a longitudinally spaced inlet and outlet defining a gas flow pathway, the access port arrangement comprising an inner part forming a core with an outer periphery and an outer part comprising a bore therethrough having an inner periphery positioned around the outer periphery of the inner part with the pathway defined by a gap between the outer periphery of the inner part and the inner periphery of the outer part, the arrangement further comprising one or more bridges that span the gap between the outer periphery of the inner part and the inner periphery of the outer part, wherein the first and second parts are formed of a refractory material.

The access port arrangement may be termed a stirring arrangement as gas is injected therethrough into a vessel, typically containing a molten metal, for the purpose of stirring the molten metal to aid in the homogeneity of the molten metal, and also to ensure that typically for molten steel the reduction in carbon and phosphorous present is maximised. In production of other metals, other impurities may be removed. Such access port arrangements may also be termed tuyeres in steel production.

Refractory materials are a category of technical ceramic materials able to withstand high temperatures, constituting a complex composite of high-melting crystalline oxides and non-oxides (e.g. carbides), carbon and graphite, metal additives and other materials such as pitch and resin. Such a definition may be found in Hubble, D. H. Steel Plant Refractories in Fruehan R. J. (Ed.) The Making, Shaping and Treating of Steel—Steelmaking and Refining Volume (11th ed.) Pittsburg (1998): The AISE Steel Foundation. Thermal cycling of refractory materials in the distal region adjacent the outlet of the tuyere due to bubble formation and the vessel process cycle cause thermo-mechanical damage in known systems however this is mitigated by using refractory materials for the inner and outer parts.

There is no metallic component provided transversely between the inner and outer part at or adjacent the outlet, i.e. at the working end/distal end of the access port assembly, nor preferably provided longitudinally extending from the outlet for the majority of the longitudinal length of the access port arrangement.

The outer part is beneficially in the form of a refractory block. The brick is therefore installed into a vessel while the working lining of the vessel is installed, and will last the lifetime of the vessel itself. The periphery of the bore is therefore beneficially of the same material as the remainder of the refractory bricks.

The access port assembly may be formed as a single element with the inner and outer parts being formed from one piece of material.

Alternatively, the inner and outer parts are formed as separate elements and brought together to form the access port assembly.

Whether the access port assembly is formed as a single element or as separate elements brought together, it is beneficial that the access port assembly is made of a refractory material, and it is beneficial that the core and the outer refractory material are pressed during manufacture to increase density, thereby reducing porosity.

The inner and outer parts are preferably co-axially spaced such that the gap is substantially uniform in a transverse direction. The gap in a transverse direction is in the range 0.1 mm to 2 mm. Further, the preferred separation is 0.8 mm to 1.2 mm. The gap preferably remains substantially constant between the inlet and outlet. The gap is preferably defined by an annulus, and the bore and the core are preferably concentric. The gap is preferably the radial separation between the core and the bore.

The outer periphery of the inner part and the inner periphery of the outer part preferably taper inwardly towards the outlet. This means that in the event of fracture of the core adjacent the outlet, the part of the core broken off will not enter into the melt material leaving a crater at the outlet which is susceptible to increased chance of failure. The degree of taper is preferably low, and may be approximately between 1 and 5 degrees, preferably substantially 3 degrees. This is less than the taper in known systems, meaning that the flow rate of the gas through the gap is almost constant throughout the entire life of the whole access port assembly.

The maximum transverse width of the bore may be less than 200 mm, and preferably less than 100 mm, and preferably in the range 60-80 mm, and preferably in the range 70-72 mm. It will be appreciated that the bore may taper towards the outlet and as such the maximum transverse width of the bore may reduce towards the outlet.

The one or more bridges are preferably integrally formed with the core. It is beneficial that the one or more bridges are machined from the core during manufacture.

The one or more bridges are preferably non-linear in the longitudinal axis. Preferably, the one or more bridges are spiralled. This is beneficial as it provides good contact between the inner and outer parts. The one or more bridges preferably extend continuously for a majority of the distance between the inlet and the outlet. This further ensures good contact as the arrangement wears over time. A majority of the distance means more than 50%, and preferably between the outlet and adjacent the inlet.

The one or more bridges may comprise a plurality of discreet bridges. The bridges may be in different forms such as circular. The bridge(s) may have a square or rectangular cross section profile.

The refractory material is preferably a magnesium oxide-carbon based refractory material. Such refractory material may be based on sintered magnesia, fused magnesia or dolomite with pitch or resin bond and also include additives of graphite and/or carbon black with carbon content up to 24%. In order to improve strength and protect the carbon against burnout the antioxidants (Al, Mg, carbides) might be added.

The access port assembly has been described with example of a BOS process, however it may also be installed in converters, steel ladles, other steel treatment vessels like degassers and tundishes, bottoms of electric arc furnaces and in bottoms of DC electric arc furnaces.

The amount of carbon in the refractory material is preferably between 10 and 30% by weight, more preferably between 12 and 20% by weight.

The refractory material may be formed with a flexible binder. Thermo-mechanical stresses resulting from combination of back-attack and cooling effect causing spalling of the refractory. Therefore material the stirring element is made of has to have good resistance to spalling. This can be achieved through increasing thermal conductivity by altering carbon content and/or improving strain to failure.

This property, sometimes called flexibility, expresses ability of refractory to withstand thermo-mechanical stresses, which can be improved for example by modifying bonding system by using combination of resin and pitch. The refractory material is preferably of relatively high thermal conductivity.

The present invention allows for a longer life time and to provide for better stirring due to the flow dynamics of the gas when passing though and out of the arrangement. The invention reduces burn-back or erosion of the access port assembly when introducing the gas into a bath of molten metal.

Also according to the present invention there is a method of manufacturing an access port assembly for the introduction of gas into a molten metal to cause stirring of the molten metal comprising providing an inner part formed of a refractory material forming a core with an outer periphery within an outer part formed of a refractory material comprising a bore therethrough having an inner periphery, the inner part being positioned such that the inner periphery of the outer part is positioned around the outer periphery of the inner part, and providing a gap between the outer periphery of the inner part and the inner periphery of the outer part to define a pathway for flow of gas, and providing one or more bridges that span the gap between the outer periphery of the inner part and the inner periphery of the outer part.

The method beneficially comprises the step of inserting the inner part into the outer part. It will be appreciated that the inner and outer parts may be formed separately and thus the inner part then inserted into the outer part to provide the access port assembly. It is beneficial that the inner part and the outer part form an interference engagement wherein the bridges ensure the gap between the outer periphery of the inner part and the inner periphery of the outer part. This defines the pathway for flow of gas therethrough.

The method also preferably comprises the step of forming the inner part to include one or more bridges on the outer periphery of the inner part. The method preferably comprises of the step of machining the one or more bridges into the inner part effectively removing matter from the formed material to leave the one or more bridges standing proud of the outer periphery of the inner part. The machining may be achieved through, for example, CNC machining.

The method may comprise the step of forming the outer part around a former, and removing the former to form the bore. It is beneficial as previously described that the inner part and outer part are formed of refractory material. The outer part is beneficially formed by pressing refractory material about a former and subsequently removing the former to form the bore. A supplementary step may be performed of additional machining to further define the bore.

Alternatively, the method may comprise the step of forming the inner and outer part around an insert, the insert defining the gap, wherein the insert has apertures such that refractory material can pass through the apertures, and heating the formed access port assembly to remove the insert.

The insert may be a perforated sheet of fugitive polymeric or cellulosic material which is removed during manufacture by pyrolysis, evaporation or dissolution. The distribution and profile of the perforations would be a matter of choice to suit the application and manufacturing method. The shape of the perforations thus defines the shape of the bridges. An advantage associated with such a method of forming the access port assembly is that the inner and outer parts can be integrally formed through forming the material about an insert and subsequently removing the insert. In the case that the access port assembly is made of refractory material, the refractory material may be pressed about the insert following which the insert can be removed.

According to an alternative aspect, there is provided a tuyere for the introduction of gas into a molten metal, said tuyere being formed of at least two parts comprising an inner part forming a core with an outer periphery and an outer part provided as a tube having a shape that that mirrors the periphery of the inner part with there being a gap between the inner and outer part, the gap providing an outlet for the gas which passes through the tuyere, characterised in that there are one or more bridges that span the gap between the inner and outer parts. Preferably the outer part is provided as an annular tube. However other shaped tubes could be used. It is envisaged that the inner part is a solid core concentrically spaced within the outer part and defining a substantially uniform annulus between the inner and outer parts. It is envisaged the outer part has a diameter of about 20 to 45 cm and an annulus between the inner part and the outer part is less than 0.010 cm. It is preferred that the first and second parts are formed of a refractory material. It is envisaged that the refractory material is of relatively high conductivity.

### BRIEF DESCRIPTION OF THE DRAWINGS

An embodiment of the invention will now be described by way of example only with reference to and as illustrated in the following figures and examples in which:

FIG. 1 is a schematic cross sectional view of a vessel into which the present invention may be utilised and in particular is schematically represented as a BOF process.

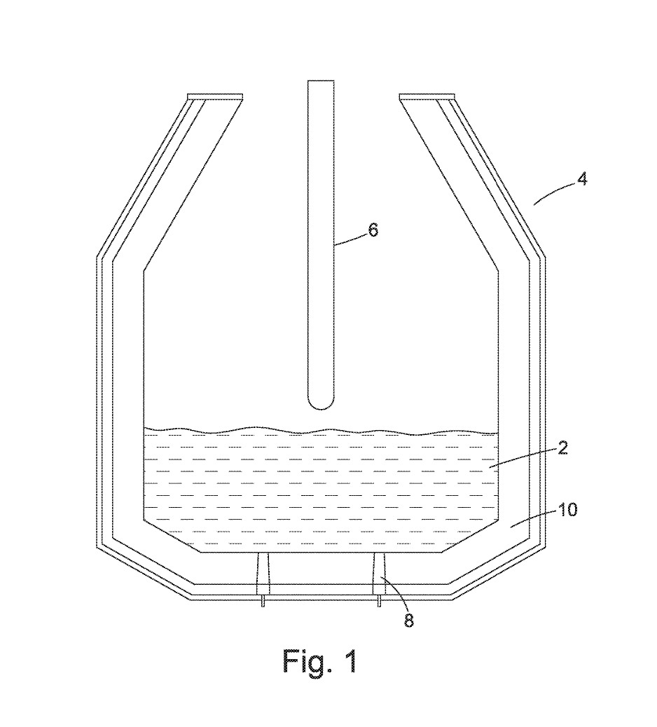

FIG. 2 is a schematic cut away view of an access port arrangement comprising a tuyere known in the art.

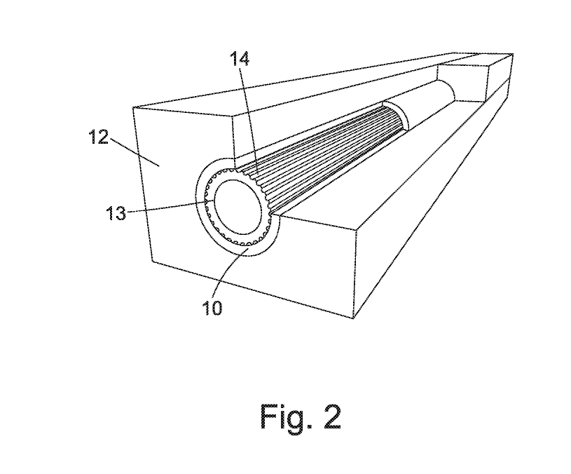

FIG. 3 is a schematic side view, cross sectional view and end view of an access port arrangement according to an exemplary embodiment of the present invention.

FIG. 4 is a schematic side view of a first and second inner part to be utilised with an access port arrangement as claimed according to exemplary embodiments.

FIG. 5 is a schematic perspective view of an insert that may be utilised during manufacture of an access port arrangement.

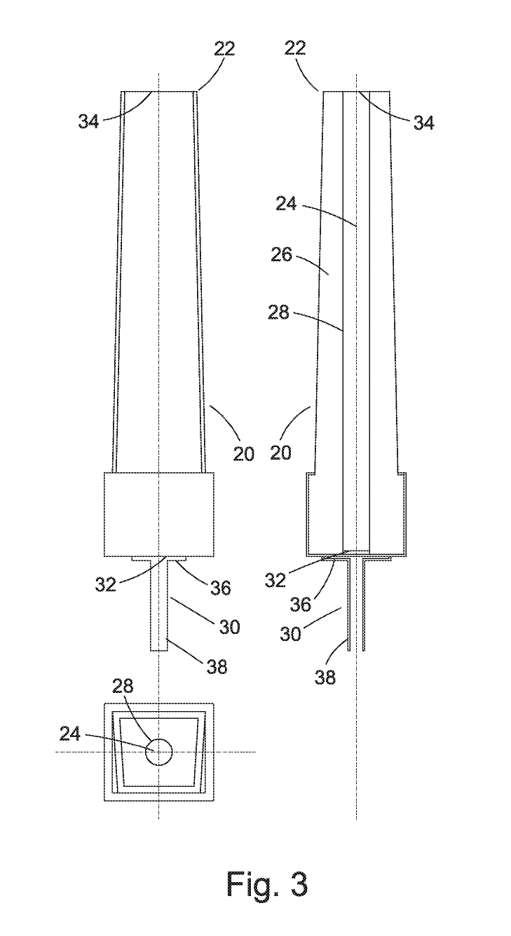

Referring now to FIG. 3, presented is an access port arrangement 20 presented in FIG. 3a as a side view, 3b as a cross sectional view and 3c as an end view viewed from the distal end 22. The tuyere 20 includes an inner part 24 and an outer part 26 concentrically spaced to define a substantially uniform gap 28 between the inner part 24 and the outer part 26. The inner part 24 may be termed the core and the outer part 26 is in the form of a brick to be inserted into and forming an integral part of a vessel. The distal end 22 forms a contact surface with the contact of the internal content of the vessel and the opposing proximal end 30 projects outwardly from the vessel. The proximal end 30 comprises an inlet 32 to the gap 28 defining a gas passage way for enabling gas to pass to the outlet 34 at the distal end 22. An arrangement 36 is provided for holding the proximal end 30 of the tuyere for engagement with a gas source via the pipe 38.

The inner part 24 may include a sheath tube forming the outer surface of the core and may be filled with a refractory material or beneficially the core itself is a very refractory material whereby the outer periphery of the core is formed of a refractory material. Thus, in a transverse direction relative to the longitudinal length of the tuyere, there is beneficially no metallic components in a transverse plane. The retaining component for retaining the proximal end of the tuyere is beneficially made from stainless steel.

The refractory material commonly is a typical material used in lining vessels for molten metal and the refractory material ideally has a relatively high thermal conductivity which helps extend the operating life of the tuyere. Typical refractory materials are magnesia-carbon and magnesia-graphite, pitch and/or resin bonded, with additives like anti-oxidants.

The inner and outer parts 24, 26 are beneficially coaxially spaced such that the gap is substantially uniform in a transverse direction. The gap in a transverse direction is beneficially in the range 0.1 mm to 2 mm. A typical range utilised for a BOF furnace is 0.8 mm to 1.2 mm. This provides and ensures good flow rate capability. If the inner and outer parts 24, 26 comprise of refractory materials, surface roughness is higher than in traditional stainless steel tuyeres and as such the flow area is beneficially increased to approximately 160 mm2.

The outer part 26 is beneficial in the form of a refractory brick for insertion directly into the structure of the vessel. A bore is provided in the outer part 26 into which the inner part 24 is provided. The external dimensions therefore of the outer part 26 may be varied depending on the vessel into which the tuyere is utilised. In the exemplary embodiment, the external dimensions may be approximately 235 mm by 211 mm. It will be appreciated, however, that the base of any vessel may be curved and as such the profile of the cross section of the tuyere is typically not square but trapezoidal. This ensures that the outer part 26 sits appropriately into the structure of the vessel.

The diameter of the inner part or core 24 is approximately 70 mm in the exemplary embodiment. This approximate diameter is provided at the outlet 34 and tapers outwardly towards the inlet 32 and the approximate diameter is 72 mm at this position. Through the provision of a tapered internal peripheral surface of the outer part 26 and mirrored tapered peripheral surface of the inner part 24 any fracture of the inner part 24 adjacent to the distal end 22 will mean that the fractured portion of the inner part 24 cannot fracture and enter the vessel but is retained within the bore of the outer part 26. This prevents deep cavities being formed on the inner surface of the vessel at the position of the tuyere leading to increased wear.

It is beneficial that the inner part or core 24 is also a material highly resistant to attack by molten steel and slag and is generally a solid core consisting of a refractory material, such as magnesium oxide (Mx0) and is beneficial as the same as the outer part 26. Preferably, the refractory material of both the inner and outer parts 24, 26 may have relatively high thermal conductivity in excess of approximately 6 W/mK. Examples of such material is magnesia-carbon refractory.

The gap or annulus 28 between the inner and outer parts 24, 26 is generally of a reduced or smaller size than known in the art. By reduction of the gap an increase in gas velocity per tuyere is achieved.

Referring to FIG. 3c the planned view of the distal end of the tuyere is presented showing the cross sectional profile of the tuyere. It can be seen that this profile is not square but is trapezoidal in order to be accommodated appropriately in a vessel.

The present invention may be incorporated into decarburisation, dephosphorisation and stirring processes as an efficient way of economically providing the total amount of gas necessary to carry out the process. Furthermore, though a steel metal bath is referred to, the invention is equally useful in molten baths of other metals. The present invention significantly improves the life of the tuyere greater than the typical 800 heating cycles in current practice in steel making processes.

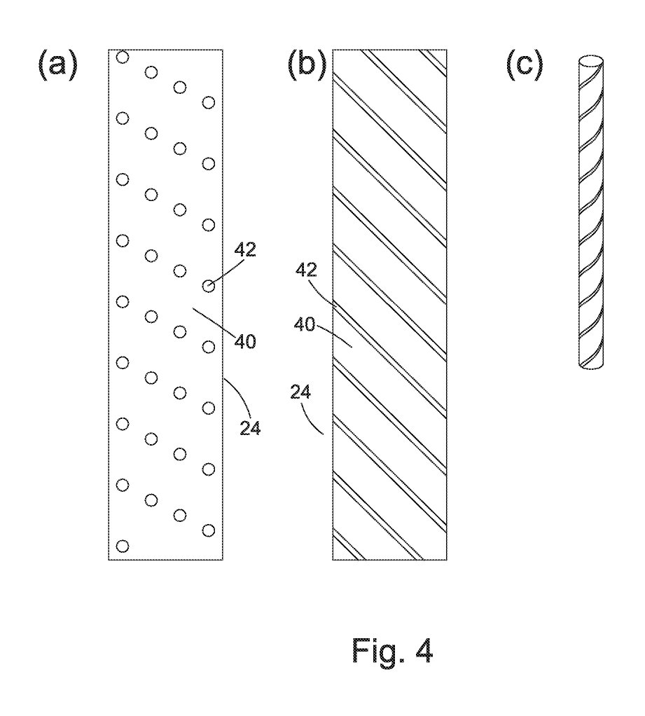

Referring to FIG. 4 there is presented an inner part 24 without the outer part 26 and shows two exemplary embodiments of an inner part 24 that may be utilised. FIG. 4a presents a first embodiment comprising an outer periphery 40 and a plurality of substantially circular bridges 42 which are beneficially integrally formed with the inner part 24. In FIG. 4a the bridges 42 project outwardly from the periphery of the inner part 40 and when inside the outer part 26 engage the inner periphery of the outer part. They may be integrally formed with both the inner periphery of the outer part and the outer periphery of the inner part. The bridges 42 provide the dual function of ensuring stability of the inner part within the outer part and also provide a flow path between the inner and outer part for the gas to transfer from the inlet to the outlet of the tuyere.

In FIG. 4b and in perspective view in FIG. 4c one or more bridges may be provided and are shown as substantially continuous projections projecting from the outer periphery of the inner part. The bridges beneficially spiral around the peripheral surface of the inner part and provide positive engagement with the inner surface of the outer part and in this embodiment the gas flow path would also be spiralled. It is beneficial in this embodiment that the bridge is substantially continuous meaning that as the inner part wears down through use at any position of wear there is always positive engagement between the inner and outer parts. In one embodiment the bridge is approximately 10 mm in width and in cross section is substantially rectangular.

The access port assembly of the present invention may be manufactured differently dependent upon particular requirements. In one manufacturing method, a core is beneficially provided made of a relatively hard material such as metal about which is pressed a refractory material. The metal core is subsequently removed leaving a bore through the refractory materials. This bore is machined to the specified diameter and beneficially taper, which then forms the inner peripheral surface of the outer part. The inner part is further manufactured by pressing a refractory material to form a truncated cone to match the surface configuration of the inner peripheral surface of the outer part. Into this are machined the one or more bridges 42 as shown for example in FIG. 4b in particular. This machined inner part is then inserted into the outer part such that the bridges 42 form interference engagement with the inner peripheral surface of the outer part.

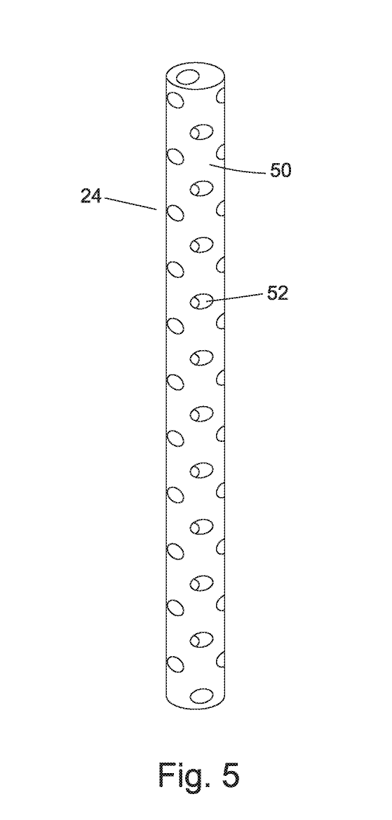

In an alternative embodiment, as presented in FIG. 5 an insert 50 is positioned into a mould about which is pressed refractory material. The refractory material fills all of the gaps about the insert. During formation the refractory material passes through the apertures of the insert 52 and forms bridges 42 between the inner and outer parts 24, 26. The bridges 42 therefore span the annual gap. The tuyere can then be heated to melt the insert 50, so that just the bridges are left spanning the gap between the inner and outer parts 24, 26. The temperature used is typically 450° C. during which plastic is burned off to leave a flow path between the inner and outer parts 24, 26 bridged by the plurality of bridges 42. It will be appreciated that the bridges 42 may have a variety of forms including circular, elliptical, or square according to flow characteristics needed for fluid passing through the access port arrangement.

Embodiments of the present invention have been presented by way of example only and it will be appreciated to the skilled addressee that modifications and variations may be made without departing from the scope of protection afforded by the appended claims.

1. An access port arrangement for the introduction of gas into a molten metal to cause stirring of the molten metal, said access port arrangement having a longitudinally spaced inlet and outlet defining a gas flow pathway, the access port arrangement comprising an inner part forming a core with an outer periphery and an outer part comprising a bore therethrough having an inner periphery positioned around the outer periphery of the inner part with the pathway defined by a gap between the outer periphery of the inner part and the inner periphery of the outer part, the arrangement further comprising one or more bridges that span the gap between the outer periphery of the inner part and the inner periphery of the outer part wherein the inner and outer parts are formed of a refractory material.

2. An access port arrangement according to claim 1 wherein the outer part is a refractory block.

3. An access port assembly according to claim 1 formed as a single element with the inner and outer parts being formed from one piece of material.

4. An access port assembly according to claim 1,
wherein the inner and outer parts are formed as separate elements and brought together to form the access port assembly.

5. An access port assembly according to claim 1
wherein the inner and outer parts are co-axially spaced such that the gap is substantially uniform in a transverse direction.

6. An access port assembly according claim 1 wherein the gap in a transverse direction is in the range 0.1 mm to 2 mm.

7. An access port assembly according claim 1 wherein the outer periphery of the inner part and the inner periphery of the outer part taper inwardly towards the outlet.

8. An access port assembly according to claim 1
wherein the maximum transverse width of the bore is less than 200 mm, and preferably less than 100 mm, and preferably in the range 60-80 mm, and preferably in the range 70-72 mm.

9. An access port assembly according to claim 1
wherein the one or more bridges are integrally formed with the core.

10. An access port assembly according to claim 1
wherein the one or more bridges are non-linear.

11. An access port assembly according to claim 1
wherein the one or more bridges extend continuously for a majority of the distance between the inlet and the outlet.

12. An access port assembly according to claim 1
wherein the one or more bridges are spiralled.

13. An access port assembly according to claim 1
wherein the one or more bridges comprise a plurality of discrete bridges.

14. An access port assembly according to claim 1
wherein the bridge has a square or rectangular cross section profile.

15. A stirring element according to claim 2,
wherein the refractory material is a magnesium oxide-carbon based refractory material.

16. An access port assembly according to claim 15, wherein the amount of carbon in the refractory material is between 10 and 30% by weight, more preferably between 12 and 20% by weight and even more preferably between 14 and 24% by weight.

17. An access port assembly according to claim 2,
wherein the refractory material is formed with a flexible binder.

18. An access port assembly according to claim 2,
wherein the refractory material is of relatively high thermal conductivity.

19. A method of manufacturing an access port assembly for the introduction of gas into a molten metal to cause stirring of the molten metal comprising providing an inner part formed of a refractory material forming a core with an outer periphery within an outer part formed of a refractory material comprising a bore therethrough having an inner periphery, the inner part being positioned such that the inner periphery of the outer part is positioned around the outer periphery of the inner part, and providing a gap between the outer periphery of the inner part and the inner periphery of the outer part to define a pathway for flow of gas, and providing one or more bridges that span the gap between the outer periphery of the inner part and the inner periphery of the outer part.

20. A method according to claim 19 comprising the step of inserting the inner part into the outer part.

21. A method according to claim 19, comprising the step of forming the inner part to include one or more bridges on the outer periphery of the inner part.

22. A method according to claim 19 comprising the step of pressing the inner part from a refractory material.

23. A method according to claim 19, comprising the step of machining the one or more bridges into the inner part.

24. A method according to claim 19 comprising the step of forming the outer part around a former, and removing the former to form the bore.

25. A method according to claim 19 comprising forming the inner and outer part around an insert, the insert defining the gap, wherein the insert has apertures such that refractory material can pass through the apertures, and heating the formed access port assembly to remove the insert.
